(19) United States
(12) Patent Application Publication
(10) Pub. No.: US 2008/0114956 A1
(43) Pub. Date: May 15, 2008

(54) SYSTEM AND METHOD TO SECURE A COMPUTER SYSTEM BY SELECTIVE CONTROL OF WRITE ACCESS TO A DATA STORAGE MEDIUM

(75) Inventors: John Safa, Nottingham (GB); Robin Grant, Wollaton (GB)

Correspondence Address: TED SABETY, c/o BERRY & ASSOCIATES, P.C., 551 MADISON AVE,, #402, NEW YORK, NY, 10022, US

(73) Assignee: DRIVE SENTRY INC., Mountain View, CA (US)

(21) Appl. No.: 11/858,713

(22) Filed: Sep. 20, 2007

Related U.S. Application Data
(60) Provisional application No. 60/826,378, filed on Sep. 20, 2006.

(51) Int. Cl. G06F 12/14

(52) U.S. Cl. 711/163

(57) ABSTRACT

A system and method of securing a computer system by controlling write access to a storage medium by monitoring an application; detecting an attempt by the application to write data to said storage medium; interrogating a rules database in response to said detection; and permitting or denying write access to the storage medium by the application in dependence on said interrogation, where the interrogation requests are queued in order manage multiple applications running on the same system.

### BACKGROUND AND SUMMARY OF THE INVENTION

This application claims priority to U.S. Patent Application 60/826378 filed on Sep. 20, 2006, which is hereby incorporated by reference. This application incorporates by reference U.S. application Ser. No. 11/292910 filed on Dec. 1, 2005.

The present invention relates to a method of controlling the writing of data to a storage medium such as a hard drive in a computer system by an application running in a memory of the computer system.

The use of computers for Internet and other communication purposes, particularly in relation to electronic mail and the downloading of applications over the Internet has led to the proliferation of so-called computer viruses. Whilst anti-virus programs have been developed to combat these, they can be relatively elaborate and expensive and usually operate to deal with an offending virus only after the operating system of the computer has been infected. There are so many variants of virus programs being released that anti-virus programs cannot identify new viruses quickly enough.

The present invention seeks to provide an improved method of preventing the infection of a computer by a virus program.

According to the present invention there is provided a method of controlling write access to a storage medium by monitoring an application; detecting an attempt by the application to write data to said storage medium; interrogating a rules database in response to said detection; and controlling write access to the storage medium by the application in dependence on said interrogation.

### BRIEF DESCRIPTION OF THE DRAWINGS

FIG. 1 is a process diagram showing the control of a write instruction of an application in accordance with a preferred method of the present invention;

FIG. 2 is a process diagram illustrating an action of the preferred method according to the present invention; and

FIG. 3 is a flow diagram of the preferred method.

FIG. 4 is a schematic showing how several processes have their write instructions queued pending a permission determination.

### DETAILED DESCRIPTION OF THE PREFERRED EMBODIMENTS

Preferably the interrogation comprises determining the write access allowed for the application and controlling the write access in dependence thereon.

Preferably write access is controlled to one of a plurality of levels, the levels including a first level in which no write access is allowed, a second level in which full write access is allowed, and a third level in which write access is only allowed for at least one specified file extension.

Preferably where write access is controlled to the first level, the method further includes generating a prompt on a display requesting response from a user.

Preferably the user can respond to the prompt by choosing from a number of possible responses, the possible responses including a first response for allowing write access, a second response for blocking write access and a third response for allowing write access to a specific file type only.

Preferably the user can respond further by selecting from a plurality of further actions, the further actions including, storing the chosen response in the rules database; and applying the chosen response only for the current attempt by the application to write data to said storage medium.

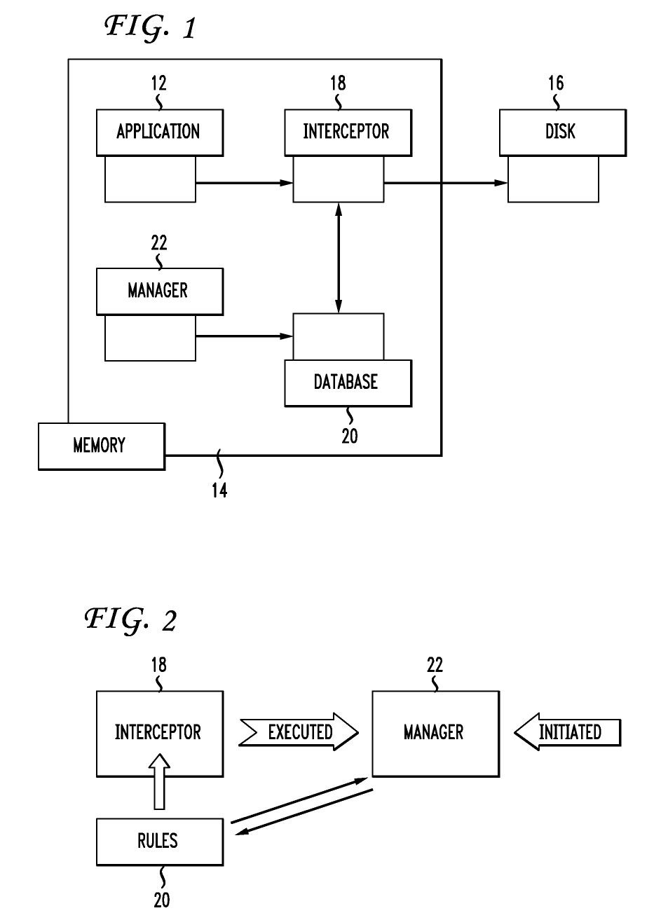

Referring firstly to FIG. 1, this shows an application 12 which is running in a memory 14 of a computer system. The computer system also has a storage medium 16 which here is in the form of a hard drive or disc.

The typical computer is comprised of a central processing unit, a main memory, a mass storage device and input and output connections. The input and output include keyboards, monitors and network connections. The mass storage device can be a magnetic disk, optical disk or a large array of semiconductor devices. The main memory is typically an array of semiconductor circuits. The central processing unit is operatively connected to these components so that it can both control their activities and move data among the components. The central processing unit can load data off of the mass storage device and write it into main memory. This data can either be treated as a program or as data to be processed. If a program, the central processing unit passes control to the program data and executes the instructions encoded in the data. Program data can be an application servicing the user.

When the computer is first booted up it automatically loads an application 18 which is here termed as an “interceptor” program. This runs constantly in the background. As an alternative to being loaded on boot up of the computer, it can, of course, be run at the user's prompt at any time whilst the computer is operating. In addition, the interceptor program can run continuously in the background as a process, including as part of the computer operating system.

When the application 12 attempts to write data to the disc 16 the interceptor program 18 detects this and interrogates a rules database 20 to determine the authority of the application 12 to write to the hard drive 16. The database 20 is preferably encrypted and lists applications approved by the user with their level of write access. The term data is used here in its general sense to include any form of data including programs. The preferred number of possible write access levels for an application is three, being as follows:
Level 0—this means that no write access to the hard drive 16 is allowed for the application 12.
Level 1—this means that full write access is allowed.
Level 2—the application is allowed write access to the hard drive 16 for specified file extensions only, (for example “.doc” file extensions for document files in Microsoft Office™) file extensions of data that can be written to the hard drive are also held in the database 20.
Level 4—The application can be granted to have access to a specific drive or directory. The database can contain corresponding references between applications and file types or file extensions that such application may write.

There are a number of rules which can be applied to the database 20 and these are controlled by a manager program 22 which can sit in the memory 14 alongside the interceptor program 18 and can also be run on start up of the computer or at any preferred time during operation of the interceptor program 18, running continuously in the background, including as part of the computer operating system.

FIG. 2 illustrates the interface of the manager program 22 with the rules database 20 and the system user.

When the interceptor program 18 detects that the application 12 is attempting to write to the hard drive 16 it initiates the loading and execution of the manager program 22. The latter interrogates the rules database 20 to determine the access level of the application 12 and controls the interceptor program 18 to allow or prevent the write action in dependence on the relevant rule in the rules database 20. If the application 12 is not listed in the rules database 20 or the particular write instruction is not allowed, the manager program 22 can generate a prompt signal to be displayed on the computer screen, requiring the user to make a decision on whether or not to allow the write instruction. This prompt can have a number of responses for the user to choose, such as “Allow write access”, “Block write access” and “Allow write access to this file type only”. Having chosen the response the user can also select one of a number of further actions as follows.
1 Store the response in the rules database—The response is stored in the rules database as a further rule to be applied to that application on all future write actions.
2 Block once the write action—This prevents the requested write action for this occasion only and further write attempts by the application again result in a user prompt.
3 Allow once the write action—This allows the requested write action but any future write requests for the application again result in a user prompt.

Thus, for example, if the application 12 is attempting to write a file to the hard drive 16 with a particular file extension, the rules database 20 can be updated such that all future attempts by the application 12 to write files of that same extension to the hard drive 16 would be automatically allowed or prevented or result in further user prompts.

Practitioners of ordinary skill will recognize that in some operating systems, including Windows™, file extensions can be arbitrarily applied to a file while the file contents are in fact something else. This common trick is used by virus writers to distribute an executable payload with an extension other then .exe (in the Windows case). Thus, users can be tricked into clicking on (in order to view) what appears to be a non-executable (a .jpg extension for a JPEG image, for example), but the computer, recognizing that internally, the file is an executable, will pass control to the program and launch it—thus propagating the virus. Therefore, where determining the “file extension” is referred to in this disclosure, it also includes detecting the actual type of file by examination of its contents, especially in the case where internally such file is an executable. Windows XP in a Nutshell, Second Edition, © 2005, O'Reilly Media, U.S.A is hereby incorporated by reference. Microsoft Windows Internals, 4th Edition: Microsoft Windows Server 2003, Windows XP, and Windows 2000, Mark E. Russinovich, David A. Solomon, Microsoft Press, Hardcover, 4th edition, Published Dec. 2004, 935 pages, ISBN 0735619174, is hereby incorporated by reference.

The manager program 22 can also be loaded and executed by the user at start up of the computer or at any time in order to scan the hard drive 16 for programs to build a full rules database 20. The manager program 22 can also be prompted by the user to display a list of programs within the rules database 20 with the access level of each program, giving the user the option to delete, add or modify each entry. In addition, a rules database can be pre-created, or incrementally improved and distributed to the computer electronically, either embodied on a disk or electronically over a data network. Rules determined by users can also be uploaded to a central depository as well. Rule updates can be downloaded into the computer. Rules can also be included with installation files for the particular application that the installation file is creating. In this case, the installation process has to be sufficiently certified that program installation does not corrupt the database by incorporating bogus rules that service virus writers. Certification can include digital signing protocols between the invention and the installing program and other modes of verifying authenticity, including remotely accessed keys or trusted third parties accessed over a network. Rules can also be derived by examining operating system data where such data presents correspondences between installed program applications and file types and extensions. In this case, other authentication may be necessary in order to avoid virus writers from inserting bogus file type associations within the operating system databases. Practitioners of ordinary skill will recognize that authentication can include cyclic redundancy checking (CRC) and other types of numerical algorithms that detect when tampering has occurred.

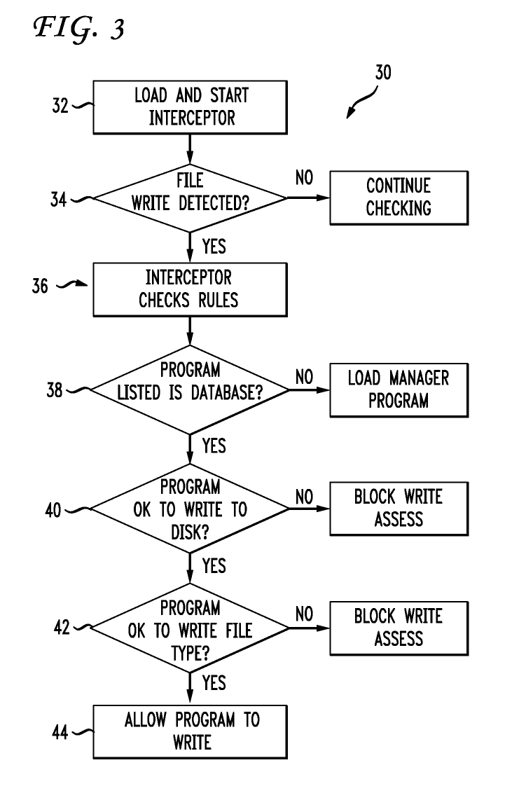

In FIG. 3 a flow diagram 30 is shown which illustrates the method followed on initiation 32 of the interceptor program 18. In the preferred embodiment, the interceptor module is a kernel mode driver which has a higher level of access to the Windows file system and system resources. Once initiated the interceptor program 18 waits in a monitoring step 34 during which it monitors for any file write operation to the hard drive 16. In the absence of a file write operation, the interceptor program 18 remains in the monitoring step 34 and continues to check for a file write operation.

If a file write operation is detected then write is pended in a queue and the interceptor program 18 proceeds to complete a series of rule checking steps 36 by calling a kernel mode rules checker. Initially the rules checker checks if the application 12 making the write attempt is listed in the rules database 20. The rules database can be stored on the local personal computer, client computer or remote server. In the preferred embodiment, a recent list of rules that have been interrogated may also be held in a cache in kernel memory cache which speeds up applications that are frequently accessing the drive. If the application 12 is not listed then the interceptor program 18 initiates the manager program 22 to allow the user to make a decision about the correct way in which to proceed. Otherwise, if the application 12 is listed then the interceptor program 18 proceeds to the next rule checking step.

On finding the application 12 listed in the rules database 20, the interceptor program 18 goes on to check if the write privileges of the application 12. Initially the hard drive write privilege of the application 12 is checked. If the application 12 does not have privilege to write to the hard drive then write access is blocked. Otherwise, the interceptor program 18 checks if the application 12 has write privilege for the specific file type, directory or filename which the write attempt has been made to. The manager program can, at this step, check the data to be written or the file to which such data is being appended to determine if the contents of the file are the appropriate file type, that is, to avoid improper creation of portable executable (PE) or other files whose contents are intended to be used as computer program code. PE files are files that are portable across all Microsoft 32-bit operating systems. The same PE-format file can be executed on any version of Windows 95, 98, Me, NT, and 2000. This is supplemental to checking the file extension in order to avoid the virus propagation technique described above. If the application 12 does have privilege to write to the specific detected file type or file extension then the write operation is allowed. Otherwise write access is blocked. A signature of the application, which is a number that is calculated to determine whether a code block has been tampered with, is also stored in the rules database. Practitioners of ordinary skill will recognize that CRC, or cyclic redundancy checks or other types of signature checking, for example, MD5 may be used. “Applied Cryptography” by Bruce Schneier, John Wiley & Sons, 1996, ISBN 0-471-11709-9 is hereby incorporated herein by reference for all that it teaches. Practitioners of ordinary skill will recognize that these techniques can also be used to authenticate the rule database that the manager program uses to verify the permission of the application. This allows trusted programs to be allowed access to the drive if their signature/structure hasn't changed, that is, the program has determined that the there has not been tampering with the application. An example is that a trusted application could be infected with a Trojan or virus and still have access to the drive based on its earlier approval being registered in the database. The manager program can use a number of criteria for the drive access of an application. The rules can be based on file name, directory name, file type, file extension, registry access and creation of specific file types.

If no rules are found for an application then a prompt module can ask the user what access level or permission they wish to allow for the application. This can involve denying or blocking the application write for that instant or for ever. The user can also get information from other users responses to a specific application by data being downloaded from a central server over a data network, both a proprietary network as well as the Internet.

The system also allows feedback on the users responses to write requests to be uploaded and stored on a central server. This stores if the user allowed or denied the application write, or what level of permission was applied and if it was denied, the reason why. The reason the user denied it can be a number of responses such as ‘virus’, ‘Trojan’ etc. The applications name and signature are stored with the reason.

An embodiment of the invention can enforce strict rules on applications writing to disk drives, memory devices, drivers, external devices or removable media. The rules can be implemented when the application first writes to the drive or via a graphical user interface or application main window. The interface permits the creation and management of a set of sophisticated rules that determine what files types, directory or drive the application can or can't write.

As a result, the invention permits a user's computer to prevent write access (in real-time) to disk or other memory by malicious programs writing to applications or destroying files. Viruses such as Nyxem can be blocked in real-time when they attempt to write over popular file types such as documents and spreadsheets.

The invention can prevent disk drive space from being wasted by blocking applications from saving downloaded media used for advertising. Typical files can be HTML pages, Flash Movies and graphics files, which, by file type, can be blocked from being saved by browser application like FireFox or Internet Explorer. Small files containing indicia about a user's web usage history, also called cookies, can be block from being written to the disk drive by blocking them being saved into a specific directory. Specific file attachments can be blocked in order to prevent applications like instant messaging tools or email clients such as screen savers and other executables from being saved.

### Watch File Access:

In another embodiment, the invention features a powerful file and registry watch which overrides the default application rules by allowing the user to monitor attempted changes of critical system files or registry keys in real-time for any attempted writes. This prevents viruses and other malicious code overwriting or damaging valuable data or modifying settings in the system registry. The user can separately specify to automatically block, allow or prompt before each action occurs. In addition, the user can specify wildcards such as *.DOC to prompt when certain files types are about to be written to and then allow the user to be prompted before the write occurs. This functionality prevents Viruses and Trojans from changing registry settings to allow themselves to start-up automatically. It also prevents Viruses and Trojans changing system files such as HOST settings. It also protects files from Virus attacks by checking before documents, spreadsheets or other valuable data are modified.

The system can also protect an entire directory by watching files being changed. If write access is approved for a device or hard drive, certain directories or files can be specified that still require a manual permission for that directory. This ensures that spurious writes to a directory or dangerous behaviour of a virus are blocked before their most destructive act takes place.

### Real-Time Logs and Charts:

In another embodiment of the invention, the software embodying the invention allows the user to view a log of all applications writing out files and registry keys. This allows the user to check what is actually being written by each application. The user can right click on any file(s) in the log list and then either open them for viewing or delete them from the drive. The activity log can also display a real-time graph of statistics that show the file and registry writes and any rules that have been modified.

In another embodiment of the invention, the system can provide additional information about applications by connecting to a service embodied in the central database accessible by a communications network. The database is populated with descriptions and recommended actions for popular applications and processes. Service also displays on the user's computer screen statistical information on the what other system users have allowed or denied writing to their computer.

### Caching:

In another embodiment of the invention, each write to disk requested by a process has to be checked by polling the system's database. That is, the identity of the process or its parent application has to be used to query the database to find what access rules apply. If the database of rules is entirely on the disk drive, this will slow down performance of a computer because for every disk access, there is another disk access required. In order to speed up this process, it is desirable to create a cache of some of the rules in the computer's main memory so that the database rules can be accessed more quickly. By way of example, the cache can be stored the name of the action (e.g. write), name of the application or process and the access writes, e.g. file type or file name or device type. The cache is typically populated by the most recently used rules. Practitioners of ordinary skill will recognize that there are many strategies for populating a cache in a computer memory. One way is to store in the cache the last distinct N database query results, where N is selected by the practicality of how large a cache in main memory can be supported. Alternatively, the cache can be populated with those rules associated with any active application, and the section of the cache devoted to a terminated application being flushed. The location of the cache is typically stored in a secure location on the computer. This typically is the kernel memory, where driver code is stored. The kernel memory is set up by the operating system to be non-writable by processes not associated with that section of kernel. In this case, the kernel memory devoted to this cache is associated only with the security system embodying the invention that is running as an application or process. Alternatively, the memory allocated to the cache can be encrypted with a check key like a CRC or MD5 so that the application can verify that the rules recovered from the encrypted cache have not been corrupted by some other application or process or virus. Any other method of securing the rule cache from tampering may be used.

### Request Queuing

In order that the security system running on the computer does not inordinately slow down the operating system, it is advantageous to queue up requests for resources and to manage the queuing process in an efficient manner. To that end, in another embodiment of the invention, a non-blocking mechanism for allocation of resources in a multiprocessing or time sharing operating system is used. The essence of the invention is that as multiple application request to write to the disk, the requests become queued. Then, the invention can select which of the queued write requests to process in accordance with the invention, generally, to determine whether the application has permission to write to the disk. The selection process can take different forms, depending on the engineering goals of the system. One method is to use a simple first in/first out technique. Another is to attach priority levels to different applications and to pick the request with the highest priority that is the oldest at that priority level. Practiotioners will recognize that many different types of schemes may be used.

In one embodiment, the user of a computer system may want to decide exactly what shared or unshared resources can be made available to a running process at any time and a control system will exist to record the users' decisions in order to process the same request again without interaction with the user. This can include the security system that is checking whether actions of the processes are acceptable, for example, writing out to disk.

Practitioners of ordinary skill will recognize that a simple first-in, first-out processing of resource requests will lead to a bottleneck in the system: the security system running the check on the request will quickly be overwhelmed. Processes previously allowed a resource will not be able to access it whilst the user or the security system is deciding on the outcome of a second processes request. That is because the computer will be checking with the user or in the system its database to determine if the process is allowed to make the access.

To alleviate this problem a dynamic queuing system is integrated into the security system. As a process is created, a resource queue in the controlling system, typically the security software, but alternatively within the confines of the operating system, is created and the queue is removed once the process has finished. Resource requests from a process go to the queue allocated for that process. In this way no single process will be blocked by another process. A queue is processed by the controlling system each iteration allowing resource allocation automatically for previous allowed requests. Once a process requests a resource that the user has not previously allowed for that process for that resource, only that queue and hence that process is blocked awaiting the users' decision. The other processes in the other queues can continue processing. By the user's affirmative decision, and it may also be the security software commencing the process of determining whether such resource is available to the process by means of reviewing its database, the blocked queue is then reactivated.

In one embodiment, the controlling system selects which queue to process using the following criteria:
1. The queue is not currently awaiting a user response, and
2. The weighted size of the queue, that is, a number related to the number of pending requests in the queue.

In order to clear longer queues faster and avoid processing empty or short queues, a normalised probability distribution can be calculated based on the current process queue lengths. The longer the queue the more likely it is to be processed. Queues that have not been processed in a long time have positively weighted queue length. This stops the system from ignoring urgent processes with few resource requests. The controlling system picks a queue to process a single request based on this probability distribution: the queue with the highest score wins.

In one embodiment, the probability of picking a queue can be calculated by dividing the weighted length of the queue with the total length of all the weighted queues in the controlling system. The controlling system randomly selects a real number between 0 and 1. All the queues in the system occupy a separate region of this number range representing the total probability space. The selected random number will fall within the selected queues range in probability space. The coding exercise is straightforward: construct a list with three columns. Each row corresponds to a queue. The second column is the start point in the space and the third column the end point. Starting with the first queue, its start point is zero and its end point is its score number. For the second row, corresponding to the second queue, the start point is the prior end point and its end point is its start point plus its score, and so-on, until all queues are represented in the list. With the randomly selected number in hand, the program marches through the list to find which row of the list has a start point less than the number and the stop point greater than the number. That row is the queue that is selected. As a result of this process, no queue is guaranteed to be selected by having the largest queue, but the probability is weighted toward that result. Practitioners of ordinary skill will recognize that there are many ways to calculate or make determination where the most needy queue gets the most attention. In addition, the weighted length of a queue can be calculated where the contribution of each pending request in the queue is further weighted by the relative priority of the process or application running the process.

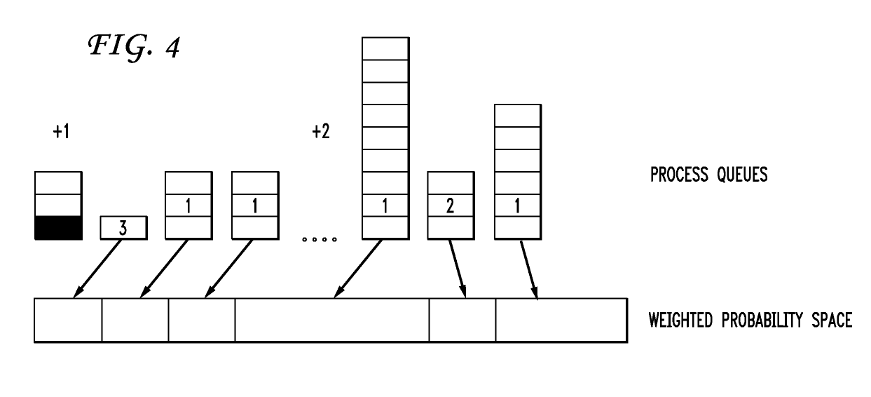

FIG. 4 shows a system of eight process queues. Queue (*1) has a pending request awaiting user interaction so it is not part of this iterations queue selection. Neither is queue (*2) as it is empty. The remaining queues have pending requests and are weighted based on number of iterations through the queue management process where they have not been selected. This will map to the probability space shown schematically below the queues in FIG. 4. The controlling system can randomly pick a value within this probability space and select the queue represented by the hit range. The next iteration will have a different calculated probability space and each queue will therefore have a less or greater chance of selection.

In another embodiment, there is one queue associated with each running application rather than one queue assigned to each process. An application may consist of one or more processes. When a new process is initiated, the queue stops execution if that is an unknown process and the user or system database is queried as described herein. Any application where the processes are known to the security system are allowed to proceed.

In another embodiment, the security system examines the contents of the one or more queues to determine if any critical operating system processes are waiting, for example, critical input-output or disk access processes. In those cases, the security system can associate a higher execution priority to those processes and move them to the top of their respective queues or move them to a new queue at the top so that they are executed promptly. In another embodiment, the security system can weight the queue such high priority requests are in so that they are more likely to be processed.

Practitioners of ordinary skill will recognize that these different queuing managements techniques may be combined. For example, the weighted queue, where the weighting is based on how old the pending request is, can be supplemented by how high a priority the process associated with the pending request is. Furthermore, practitioners of ordinary skill will recognize that the where each process or application has its own queue, and the invention is selecting which pending request to process from the set of pending queues, the invention, when it determines that a particular process or application is permitted, can process more than one of the queued requests of the permitted application at once. This may be accomplished where the destination file is the same for the set of requests.

Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The spirit and scope of the present invention are to be limited only by the terms of the appended claims.

What is claimed:

1. In a computer comprising a central processing unit operatively connected to a storage medium and at least one application running on said central processing unit, a method of controlling write access to said storage medium by said at least one application comprising:
detecting at least one request by the at least one application to write data to said storage medium;
queuing the at least one request into one of at least one queue, said at least one queue corresponding to the at least one application;
selecting a queue to process from the at least one queues;
selecting a request to process from the selected queue;
determining a permission value associated with the application corresponding to the selected request, wherein said permission value encodes at least two states, the first a permission for said application to write said data and the second a denial of permission to for said application to write said data; and
controlling write access to the storage medium by the application in dependence on the state of said permission value.

2. The method of claim 1 where the queue selection step is comprised of determining which queue of the at least one queue has the highest score, said score being calculated as a function dependent on the number of pending requests in the queue.

3. The method of claim 2 where the function is further dependent on the time the queue has been waiting to be processed.

4. The method of claim 1 where the queue selection step is comprised of:
For each queue, calculating a first number by dividing the weighted length of the queue by the total length of all of the at least one weighted queue lengths;
Organizing the first numbers into a data structure representing the position of each queue in a probability space between 0 and 1;
Randomly selecting an approximate real, second number between 0 and 1;
Selecting the queue whose range in the probability space bounds the second number.

5. The method of claim 4 where any queue associated with a process whose permission value is either not available to the computer or is a denial of permission to write, is not included in said calculation and selection steps.

6. The method of claim 4 where any queue associated with a request that is pending the interaction with the user of the computer is not included in said calculation and selection steps.

7. The method of claim 1 where the queue selection step is comprised of determining which queue has the highest priority, said priority being that associated with the application corresponding to the queue.

8. The method of claim 1 where the queue selection step first determines the queue of highest priority and, where more than one queue share the same highest priority, selects the queue with the highest score, said score being calculated as a function dependent on the number of pending requests in the queue.

9 The method of claim 8 where the priority of a queue is dependent on whether or not its associated application is an operating system process.

10. The method of claim 1 further comprising:
determining that a queued request is a critical operating system process;
moving the request forward in the queue.

11. The method of claim 1 further comprising:
determining that a queued request is a critical operating system process;
assigning a priority level associated with operating system processes to the request.

12. The method of claim 1 where the queue selection step is comprised of disqualifying any queue with a request pending user approval of the request.

13. The method of claim 1 where the queue selection step is comprised of disqualifying any queue of zero length.

14. The method of claim 1 where the queue selection step is comprised of determining which queue has the highest priority, said priority being that associated with the corresponding at least one application.

15. The method of claim 1 where the queue selection step is comprised of disqualifying any queue associated with an at least one application whose associated permission value is unavailable to the computer.

16. The method of claim 1 where the permission value is dependent on the filetype of the target location of the write request.

17. The method of claim 16 where the file type is determined by inspection of the data that the request is attempting to write.

18. A method as claimed in claim 1 where write access is denied if no permission value corresponding to the application is determined.

19. The method of claim 1 with the further step of generating a prompt on a user interface requesting response from a user, accepting such response, and using such response to generate the determined permission value.

20. The method according to claim 1 with the additional steps of:
receiving into said computer data representing at least one permission value.

21. The method of claim 1 further comprising the step of uploading at least one permission value from said computer to an additional computer over a data communications network.

22. The method of claim 1 further comprising the step of downloading from an additional computer over a data communications network at least one permission value.

23. The method of claim 1 where the queue selection step excludes the queue associated with a request that is pending approval by the user of the computer.

24. The method of claim 23 where the permission value is dependent on the filetype of the target location of the write request.

25. The method of claim 24 where the file type is determined by inspection of the data that the request is attempting to write.

26. A method as claimed in claim 23 where write access is denied if no permission value corresponding to the application is determined.

27. The method of claim 23 with the further step of generating a prompt on a user interface requesting response from a user, accepting such response, and using such response to generate the determined permission value.

28. The method according to claim 23 with the additional steps of:
receiving into said computer data representing at least one permission value.

29. The method of claim 23 further comprising the step of uploading at least one permission value from said computer to an additional computer over a data communications network.

30. The method of claim 23 further comprising the step of downloading from an additional computer over a data communications network at least one permission value.

31. The method of claim 1 where all of the remaining requests in the queue associated with one of the at least one applications are executed without re-checking the permission value once the first request in the queue associated with said one application has been determined to be permitted to write to the storage medium.

32. The method of claim 1 where the queue selection step is comprised of determining on a first in first out basis, where requests associated with unavailable permission values or pending interaction with the user are ignored.

33. The method of claim 1 where the queue selection step is comprised of determining on a random selection basis.

34. The method of claim 1 where the queue selection step is comprised of determining on a weighted random selection basis.

35. The method of claim 1 where the queue selection step is comprised of determining on the basis of how long the queues are.

36. The method of claim 1 where the queue selection step is comprised of determining on the basis of how long the queues have been waiting.

37. The method of claim 1 where the queue selection step is comprised of determining on the basis of the priority of the processes associated with the queues.

38. A computer system comprising a storage medium, a central processing unit and a main memory, where said central processing unit executes any of the methods of claims 1-37.

39. A computer readable data storage medium containing digital data that, when loaded into a computer and executed as a program, causes the computer to execute any of the methods of claims 1-37.
